(19) United States
(12) Patent Application Publication
(10) Pub. No.: US 2021/0315166 A1
(43) Pub. Date: Oct. 14, 2021

(54) Openable Plant Pot Assembly

(71) Applicant: James Wilson, Levittown, PA (US)

(72) Inventor: James Wilson, Levittown, PA (US)

(21) Appl. No.: 16/844,072

(22) Filed: Apr. 9, 2020

(51) Int. Cl. A01G 9/02

(52) U.S. Cl. CPC A01G 9/02; A01G 2009/003

(57) ABSTRACT

An openable plant pot assembly for replacing soil in a plant pot without disturbing a plant growing in the plant pot includes a plant pot vertically divided into a first half that is hingedly coupled to a second half. In this way the plant pot is positionable in an open position for replacing soil in the plant pot without disturbing roots of a plant that is growing in the plant pot. A pair of closures is each of the closures is coupled to the plant pot. A pair of engagements is each coupled to the plant pot. Each of the closures releasably engages a respective one of the engagements for retaining the plant pot in the closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to plant pot devices and more particularly pertains to a new plant pot device for replacing soil in a plant pot without disturbing a plant growing in the plant pot.

### (2) Description of Related Art Including Information Disclosed Under 37 CFR 1.97 and 1.98

The prior art relates to plant pot devices including a variety of plant pots that comprise a first portion that is positionable within a second portion. The prior art discloses a variety of plant pots that are divided into a first half and a second half thereby facilitating the plant pots to be spit open for replacing soil. The variety of plant pots that are divided generally includes a base that is a single piece. The prior art also discloses a plant pot that is comprised of a translucent material thereby facilitating roots of a plant to be visible in the plant pot.

### BRIEF SUMMARY OF THE INVENTION

An embodiment of the disclosure meets the needs presented above by generally comprising a plant pot vertically divided into a first half that is hingedly coupled to a second half. In this way the plant pot is positionable in an open position for replacing soil in the plant pot without disturbing roots of a plant that is growing in the plant pot. A pair of closures is each of the closures is coupled to the plant pot. A pair of engagements is each coupled to the plant pot. Each of the closures releasably engages a respective one of the engagements for retaining the plant pot in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an openable plant pot assembly according to an embodiment of the disclosure.

FIG. 2 is a perspective view of an embodiment of the disclosure showing a plant pot being positioned in an open position.

FIG. 3 is a bottom view of an embodiment of the disclosure.

FIG. 4 is a front view of an embodiment of the disclosure.

FIG. 5 is a back view of an embodiment of the disclosure.

FIG. 6 is a cross sectional view taken along line 6-6 of FIG. 4 of an embodiment of the disclosure.

### DETAILED DESCRIPTION OF THE INVENTION

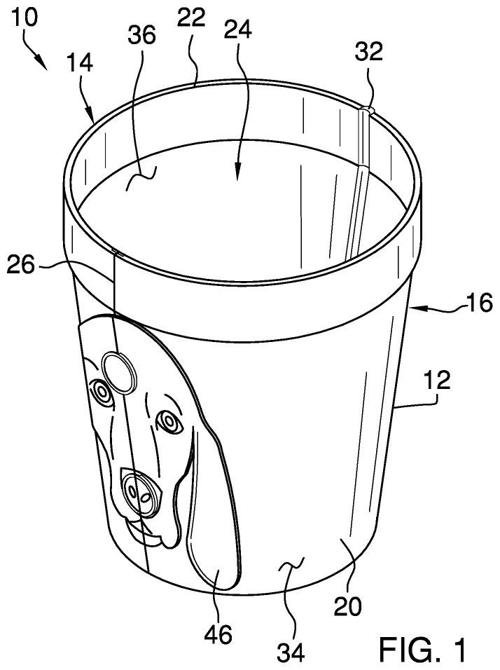

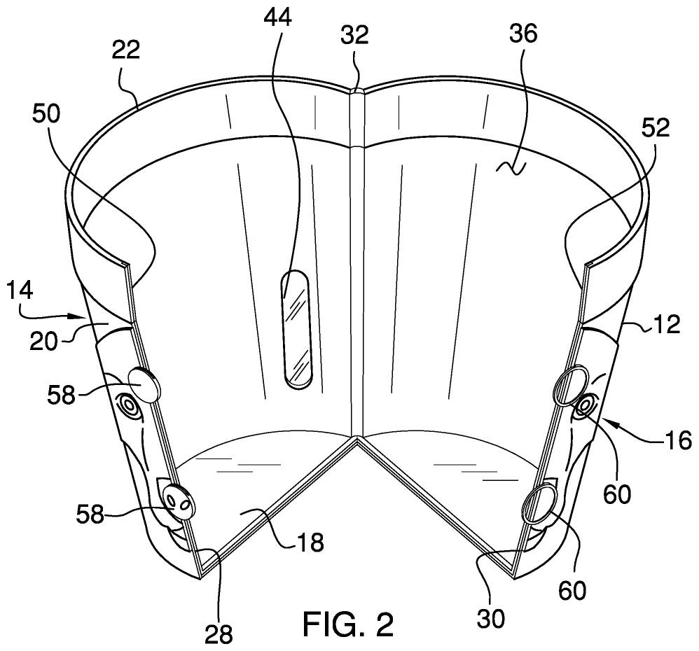

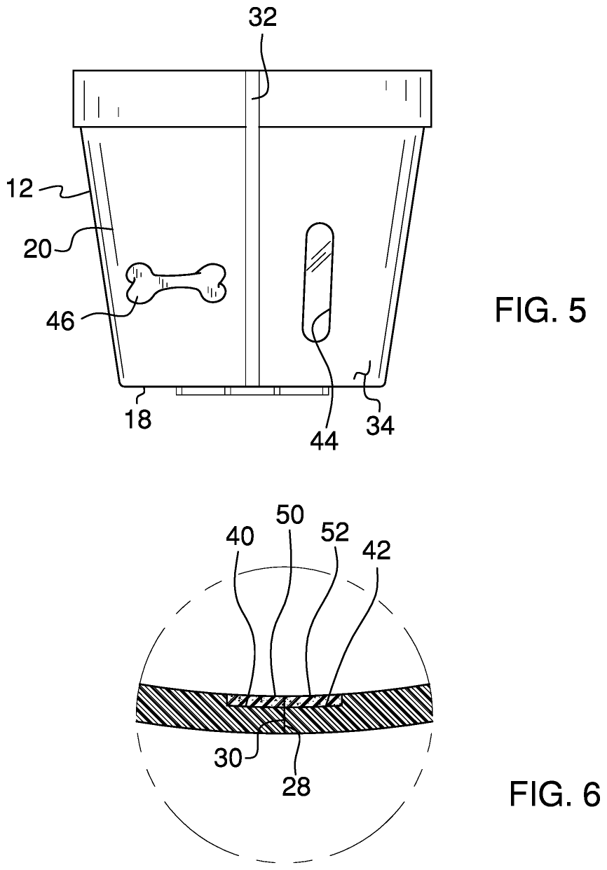

With reference now to the drawings, and in particular to FIGS. 1 through 6 thereof, a new plant pot device embodying the principles and concepts of an embodiment of the disclosure and generally designated by the reference numeral 10 will be described.

As best illustrated in FIGS. 1 through 6, the openable plant pot assembly 10 generally comprises a plant pot 12 that is vertically divided into a first half 14 that is hingedly coupled to a second half 16. In this way the plant pot 12 can be positioned in an open position for replacing soil in the plant pot 12 without disturbing roots of a plant that is growing in the plant pot 12. The plant pot 12 has a bottom wall 18 and an outer wall 20 extending upwardly therefrom, and the outer wall 20 has a distal edge 22 with respect to the bottom wall 18 to define an opening 24 into the pot. The plant pot 12 has a cut 26 extending through the outer wall 20 and the bottom wall 18 to define the first half 14 and the second half 16 of the plant pot 12. The cut 26 has a first bounding edge 28 and a second bounding edge 30, and the first bounding edge 28 abuts the second bounding edge 30 when the plant pot 12 is in a closed position. The first bounding edge 28 is spaced from the second bounding edge 30 when the plant pot 12 is in a closed position.

The plant pot 12 has a hinge portion 32 extending between the distal edge 22 of the outer wall 20 and the bottom wall 18. The hinge portion 32 is positioned on an opposite side of the outer wall 20 from the cut 26. The hinge portion 32 is comprised of a flexible material thereby facilitating the first half 14 and the second half 16 to be moved between the open position and the closed position. The outer wall 20 has an outer surface 34 and an inner surface 36, and the bottom wall 18 has a bottom surface 38. The inner surface 36 has a first slot 40 extending toward the outer surface 34 and the first slot 40 is positioned adjacent to the first bounding edge 28 of the cut 26. Moreover, the first slot 40 extends along a full height of the outer wall 20. The inner surface 36 has a second slot 42 extending toward the outer surface 34 and the second slot 42 is positioned adjacent to the second bounding edge 30 of the cut 26. The second slot 42 extends along a full height of the outer wall 20.

The outer wall 20 has an opening 44 extending therethrough. The outer surface 34 of the outer wall 20 has indicia 46 thereon and the indicia 46 comprise imagery of animals, plants or other natural objects. A window 48 is coupled to the plant pot 12 to facilitate roots of the plant in the plant pot 12 to be visible when the plant pot 12 is in the closed position. The window 48 is aligned with the opening 44 in the outer wall 20 of the plant pot 12 and the window 48 is comprised of a translucent material.

A first gasket 50 is positioned in the first slot 40 and the first gasket 50 extends along a full length of the first slot 40. A second gasket 52 is positioned in the second slot 42 and the second gasket 52 extends along a full length of the second slot 42. The first gasket 50 abuts the second gasket 52 when the plant pot 12 is positioned in the closed position such that the first gasket 50 forms a fluid impermeable seal with the second gasket 52. In this way the first gasket 50 and the second gasket 52 inhibit water from passing through the cut 26 when the plant pot 12 is in the closed position. Each of the first gasket 50 and the second gasket 52 may be comprised of a resiliently compressible material such as rubber or the like.

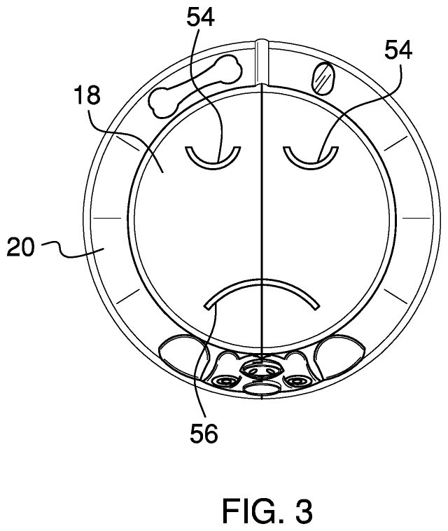

A pair of first feet 54 is each coupled to the bottom wall 18 and each of the first feet 54 is positioned on the bottom surface 38 of the bottom wall 18. Each of the first feet 54 is positioned on a respective one of the first half 14 and the second half 16 of the plant pot 12. As is most clearly shown in FIG. 3, each of the first feet 54 may be concavely arcuate on the bottom wall 18. A second foot 56 is coupled to the bottom wall 18 and the cut 26 extends through the second foot 56. As is most clearly shown in FIG. 3, the second foot 56 may be concavely arcuate on the bottom wall 18. Additionally, the second foot 56 may have a length that is greater than either of the first feet 54.

A pair of closures 58 is each coupled to the plant pot 12 and each of the closures 58 is positioned on the first half 14 of the plant pot 12. Each of the closures 58 is positioned on the outer surface 34 of the outer wall 20 of the plant pot 12. Each of the closures 58 is aligned with the first bounding edge 28 of the cut 26 and each of the closures 58 extends outwardly beyond the first bounding edge 28. A pair of engagements 60 is each coupled to the plant pot 12 and each of the closures 58 releasably engages a respective one of the engagements 60 for retaining the plant pot 12 in the closed position. Each of the closures 58 may comprise a disk and each of the engagements 60 may comprise a ridge for the disk to frictionally engage.

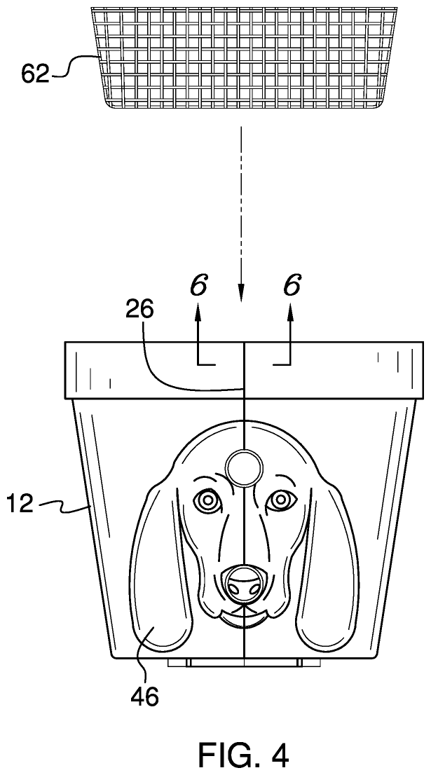

As is shown in FIG. 4, a basket 62 is provided and the basket 62 is positionable in the plant pot 12 prior to planting the plant in the plant pot 12. The basket 62 can be gripped with the plant pot 12 is opened for supporting the plant. Moreover, the basket 62 facilitates soil to pass therethrough to facilitate the soil to be replaced.

In use, the plant pot 12 is positioned in the closed position and the plant pot 12 is filled with soil for growing a plant. The roots of the plant can be observed through the window 48 in the plant pot 12. The plant pot 12 can be positioned in the open position to facilitate the soil to be replaced. Thus, the plant can remain in place while the soil is being replaced. In this way the plant pot 12 reduces stress on the plant that would normally be associated with removing the plant from the plant pot 12 during soil replacement.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An openable plant pot assembly being splittable into an open position for replacing soil without disturbing roots of a plant, said assembly comprising:
a plant pot being vertically divided into a first half being hingedly coupled to a second half such that said plant pot is positionable in an open position for replacing soil in said plant pot without disturbing roots of a plant that is growing in said plant pot;
a window being coupled to said plant pot wherein said window is configured to facilitate roots of the plant in said plant pot to be visible when said plant pot is in said closed position, said window being aligned with said opening in said outer wall of said plant pot;
a pair of first feet, each of said first feet being coupled to said bottom wall, each of said first feet being positioned on said bottom surface of said bottom wall, each of said first feet being positioned on a respective one of said first half and said second half of said plant pot;
a second foot being coupled to said bottom wall, said second foot having said cut extending therethrough;
a pair of closures, each of said closures being coupled to said plant pot; and
a pair of engagements, each of said engagements being coupled to said plant pot, each of said closures releasably engaging a respective one of said engagements for retaining said plant pot in said closed position.

2. The assembly according to claim 1, wherein said plant pot has a bottom wall and an outer wall extending upwardly therefrom, said outer wall having a distal edge with respect to said bottom wall to define an opening into said pot, said plant pot having a cut extending through said outer wall and said bottom wall to define said first half and said second half of said plant pot, said cut having a first bounding edge and a second bounding edge, said first bounding edge abutting said second bounding edge when said plant pot is in a closed position, said first bounding edge being spaced from said second bounding edge when said plant pot is in a closed position, said outer wall having an outer surface and an inner surface, said bottom wall having a bottom surface.

3. The assembly according to claim 2, wherein said plant pot has a hinge portion extending between said distal edge of said outer wall and said bottom wall, said hinge portion being positioned on an opposite side of said outer wall from said cut, said hinge portion being comprised of a flexible material thereby facilitating said first half and said second half to be moved between said open position and said closed position.

4. The assembly according to claim 2, wherein said inner surface has a first slot extending toward said outer surface, said first slot being positioned adjacent to said first bounding edge of said cut, said first slot extending along a full height of said outer wall.

5. The assembly according to claim 4, wherein said inner surface has a second slot extending toward said outer surface, said second slot being positioned adjacent to said second bounding edge of said cut, said second slot extending along a full height of said outer wall.

6. The assembly according to claim 2, wherein said outer wall has an opening extending therethrough.

7. The assembly according to claim 2, wherein said outer surface of said outer wall has indicia thereon, said indicia comprising imagery of animals, plants or other natural objects.

8. The assembly according to claim 5, further comprising a first gasket being positioned in said first slot, said first gasket extending along a full length of said first slot.

9. The assembly according to claim 8, further comprising a second gasket being positioned in said second slot, said second gasket extending along a full length of said second slot, said first gasket abutting said second gasket when said plant pot is positioned in said closed position such that said first gasket forms a fluid impermeable seal with said second gasket wherein said first gasket and said second gasket are configured to inhibit water from passing through said cut when said plant pot is in said closed position.

10. The assembly according to claim 2, wherein:
each of said closures is positioned on said first half of said plant pot, each of said closures being positioned on said outer surface of said outer wall of said plant pot, each of said closures being aligned with said first bounding edge of said cut, each of said closures extending outwardly beyond said first bounding edge; and
each of said engagements is aligned with said second bounding edge of said cut.

11. An openable plant pot assembly being splittable into an open position for replacing soil without disturbing roots of a plant, said assembly comprising:
a plant pot being vertically divided into a first half being hingedly coupled to a second half such that said plant pot is positionable in an open position for replacing soil in said plant pot without disturbing roots of a plant that is growing in said plant pot, said plant pot having a bottom wall and an outer wall extending upwardly therefrom, said outer wall having a distal edge with respect to said bottom wall to define an opening into said pot, said plant pot having a cut extending through said outer wall and said bottom wall to define said first half and said second half of said plant pot, said cut having a first bounding edge and a second bounding edge, said first bounding edge abutting said second bounding edge when said plant pot is in a closed position, said first bounding edge being spaced from said second bounding edge when said plant pot is in a closed position, said plant pot having a hinge portion extending between said distal edge of said outer wall and said bottom wall, said hinge portion being positioned on an opposite side of said outer wall from said cut, said hinge portion being comprised of a flexible material thereby facilitating said first half and said second half to be moved between said open position and said closed position, said outer wall having an outer surface and an inner surface, said bottom wall having a bottom surface, said inner surface having a first slot extending toward said outer surface, said first slot being positioned adjacent to said first bounding edge of said cut, said first slot extending along a full height of said outer wall, said inner surface having a second slot extending toward said outer surface, said second slot being positioned adjacent to said second bounding edge of said cut, said second slot extending along a full height of said outer wall, said outer wall having an opening extending therethrough, said outer surface of said outer wall having indicia thereon, said indicia comprising imagery of animals, plants or other natural objects;
a window being coupled to said plant pot wherein said window is configured to facilitate roots of the plant in said plant pot to be visible when said plant pot is in said closed position, said window being aligned with said opening in said outer wall of said plant pot;
a first gasket being positioned in said first slot, said first gasket extending along a full length of said first slot;
a second gasket being positioned in said second slot, said second gasket extending along a full length of said second slot, said first gasket abutting said second gasket when said plant pot is positioned in said closed position such that said first gasket forms a fluid impermeable seal with said second gasket wherein said first gasket and said second gasket are configured to inhibit water from passing through said cut when said plant pot is in said closed position;
a pair of first feet, each of said first feet being coupled to said bottom wall, each of said first feet being positioned on said bottom surface of said bottom wall, each of said first feet being positioned on a respective one of said first half and said second half of said plant pot;
a second foot being coupled to said bottom wall, said second foot having said cut extending therethrough;
a pair of closures, each of said closures being coupled to said plant pot, each of said closures being positioned on said first half of said plant pot, each of said closures being positioned on said outer surface of said outer wall of said plant pot, each of said closures being aligned with said first bounding edge of said cut, each of said closures extending outwardly beyond said first bounding edge; and
a pair of engagements, each of said engagements being coupled to said plant pot, each of said closures releasably engaging a respective one of said engagements for retaining said plant pot in said closed position.
